(19) United States
(12) Patent Application Publication
(10) Pub. No.: US 2008/0104651 A1
(43) Pub. Date: May 1, 2008

(54) PROCEDURE CONTROL METHOD FOR SIMPLEX SYSTEM

(75) Inventor: Yang-Hsin Fan, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/782,139

(22) Filed: Jul. 24, 2007

(30) Foreign Application Priority Data
Oct. 26, 2006 (TW) 95139503

(51) Int. Cl. H04N 7/173

(52) U.S. Cl. 725/118

(57) ABSTRACT

A procedure control method for a simplex system is provided. The method can be applied to the simplex system of a digital TV and includes the following steps: transmitting a first communication message to a corresponding system and requiring the corresponding system to respond to the first communication message in a first specific procedure; continually executing procedures of a major loop of the simplex system; when the first specific procedure is re-executed in the major loop, processing the response of the corresponding system for the first communication message in a first sub-procedure of the first specific procedure.

### CROSS-REFERENCE TO RELATED APPLICATION

This application claims the priority benefit of Taiwan application serial no. 95139503, filed on Oct. 26, 2006. All disclosure of the Taiwan application is incorporated herein by reference.

### BACKGROUND OF THE INVENTION

1. Field of the Invention

The present invention relates to a procedure control method, and more particularly to a procedure control method for a simplex system in a digital TV.

2. Description of Related Art

In a loosely coupled framework, a system (e.g. a digital TV) can be composed of modules with different functions, and the modules can communicate with each other through a communication protocol. The digital TV usually includes a host system and a digital TV module. The digital TV module serves to receive and convert a broadcast signal and transmit it to the host system, and the host system serves to adjust (e.g. a scaler integrated circuit in the host system) and display the received broadcast signal. In the conventional art, a host system is usually a simplex system, while a digital TV module can be a multiplex system.

A procedure control method for a conventional simplex system is shown in FIG. 1, and FIG. 1 is a flowchart of the procedure control method for the simplex system according to the conventional art. A simplex system 100 includes N procedures which are respectively represented by Steps S1(1)-S1(N). Upon executing, only when a procedure presently executed (e.g., Procedure 1) is finished, the next procedure (e.g., Procedure 2) can be executed. Accordingly, during the executing period, if one procedure presently executed is not finished (e.g., waiting for data), the next procedure cannot be executed. When the simplex system 100 finishes executing the last procedure (e.g., Procedure N), it will go back to Step S1(1) and execute Procedure 1, and the loop in the simplex system 100 will be re-executed.

Because a simplex system cannot execute various procedures simultaneously and only when a procedure presently executed is finished the next procedure can be executed, when the host system needs to conduct a data transmission and communication with the digital TV module, the host system will usually execute the next procedure only if it receives a feedback or an confirmation from the digital TV module. Accordingly, when the digital TV module is busy or cannot respond to the host system immediately, an operation resource is wasted and the overall performance of the digital TV is reduced as well.

### SUMMARY OF THE INVENTION

Accordingly, the present invention is directed to providing a procedure control method, which is suitable for a simplex system in a digital TV (e.g., a scaler IC in a host system), and uses a sub-procedure to process a communication requirement and response between the host system and a digital TV module and thus avoids a waste of the operation performance in the host system due to the digital TV module being busy.

In order to achieve the above and other objectives, the present invention provides a procedure control method for a simplex system in a digital TV. The above simplex system has a major loop with multiple procedures. The above procedure control method comprises the following steps: first, transmitting a first communication message to a corresponding system and requiring the corresponding system to respond to the first communication message in a specific procedure (which can be referred to as a first specific procedure); then, continually executing procedures of the major loop; and, when the first specific procedure is re-executed in the major loop, processing the response of the corresponding system for the first communication message in a first sub-procedure, wherein the first sub-procedure corresponds to the first specific procedure.

In another embodiment of the present invention, the first sub-procedure of the first specific procedure comprises a first transmitting sub-procedure for transmitting the first communication message to the corresponding system, and a first processing sub-procedure for processing the response of the corresponding system for the first communication message. The corresponding system can be a digital TV system.

In another embodiment of the present invention, in the step of continually executing procedures of the major loop, if a second communication message is output to the corresponding system and the corresponding system is required to respond to the second communication message in another specific procedure (which can be referred to a second specific procedure), when the second specific procedure is re-executed in the major loop, the response of the corresponding system for the second communication message is processed in a second sub-procedure, wherein the second sub-procedure corresponds to the second specific procedure.

In another embodiment of the present invention, if the corresponding system responds to the second communication message, a response message from the corresponding system is firstly stored in a buffer area.

The idea of sub-procedures according to the present invention can be applied to improve a communication procedure between a host system and a digital TV module in a digital TV. When the digital TV module is busy or cannot respond immediately, the host system can directly execute the next procedure, thereby avoiding a reduced performance of the digital TV due to waiting for a response.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a flowchart of a procedure control method for a simplex system according to the conventional art.

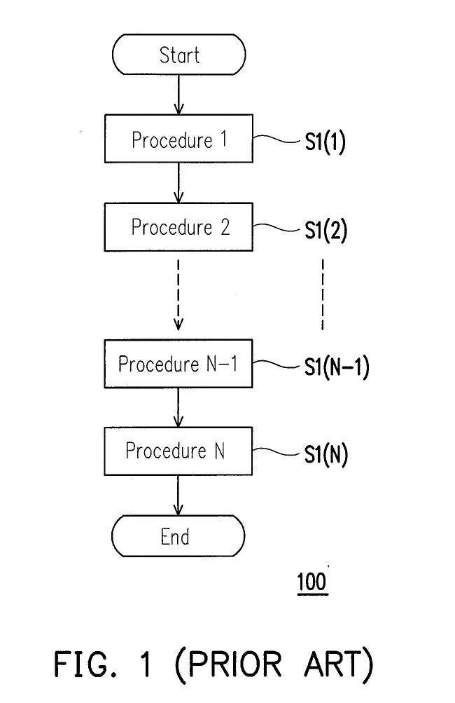

FIG. 2 is a flowchart of a procedure control method according to an embodiment of the present invention.

FIG. 3 is a schematic view of a digital TV system according to another embodiment of the present invention.

FIG. 4 is a flowchart of a sub-procedure according to another embodiment of the present invention.

FIG. 5 is a flowchart of a procedure control method according to another embodiment of the present invention.

### DESCRIPTION OF EMBODIMENTS

It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

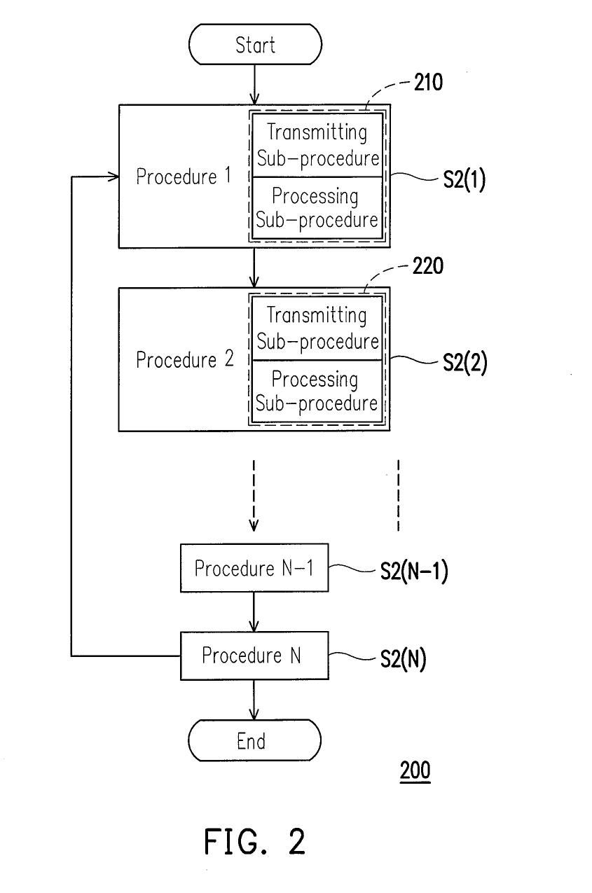

FIG. 2 is a flowchart of a procedure control method according to an embodiment of the present invention. This procedure control method is suitable for a simplex system, for example, a host system or a scaler IC in a digital TV. Referring to FIG. 2, Steps S2(1)˜S(N) respectively represent Procedures 1-N in a simplex system 200. Procedures 1-N makes up a major loop in the simplex system 200, and when the system finishes executing Procedures 1 to N, it goes back to Step S2(1) to execute Procedure 1.

If some specific procedures (e.g., Procedures 1 and 2) need to conduct a communication or data transmission and confirmation with other corresponding systems (e.g., a digital TV module), sub-procedures are added in the specific procedures (e.g., a first sub-procedure 210 and a second sub-procedure 220, which are shortly referred to as Sub-procedure 210 and Sub-procedure 220 respectively hereinafter), for processing a communication between the simplex system 200 and other corresponding systems. Taking Procedure 1 as an example, when Procedure 1 needs to conduct a transmission or confirmation of a communication message (e.g., a data, command, requirement or confirmation and so on, and the communication message of Procedure 1 in this embodiment is referred to as a first communication message) with other corresponding systems or corresponding modules, the Procedure 1 can make Sub-procedure 210 responsible for the action of transmitting the communication message.

Sub-procedure 210 includes a transmitting sub-procedure and a processing sub-procedure. The transmitting sub-procedure serves to transmit a communication message and the processing sub-procedure serves to process a response of a corresponding system. In this embodiment, Sub-procedure 210 first transmits a communication message to a corresponding system via the transmitting sub-procedure and then the state of Sub-procedure 210 is switched to the processing sub-procedure so as to wait for execution of the next procedure. Then, the simplex system 200 directly executes the next procedure (Procedure 2) and does not wait for a response or a confirmation from the corresponding system. When the simplex system 200 re-executes Procedure 1 in Step S2(1), Procedure 1 goes again into Sub-procedure 210 to confirm whether the corresponding system has responded to the communication transmitted previously. That is, Procedure 1 goes into the processing sub-procedure of Sub-procedure 210, if a response message from the corresponding system has been returned, a corresponding processing is performed, and if the corresponding system has not responded, the message requiring a response can be retransmitted or the response requirement can be cancelled, according to the settings of the simplex system 200. Thus, Sub-procedure 210 only executes one state (for example, transmitting a requirement or processing a response message) each time, and only when Procedure 1 is re-executed in the major loop, Sub-procedure 210 executes the next state.

If it is needed to transmit a communication message (e.g., a second communication message) or require the corresponding system to respond in Procedure 2, Sub-procedure 220 is executed, and the next procedure (Procedure 3) in the major loop is directly executed. Only when Procedure 2 is re-executed in the major loop in Step S2(2), the simplex system 200 goes again into Sub-procedure 220 and processes the response of the corresponding system according to the state of Sub-procedure 220. In this embodiment, only two procedures needing to communicate with the rest modules or systems are taken as an example to illustrate a main technical manner of the present invention. However, the present invention can also be suitable for a simplex system with multiple procedures needing to communicate with the rest modules or systems, the implementation of which will be readily deduced by those of ordinary skill in the art through the disclosure of the present invention, and thus will not be described herein.

In a practical application, for example, a simplex system in a digital TV (e.g., a host system or a scaler IC), the technical manner of the present invention can be applied to control a communication procedure between the simplex system and a corresponding system (e.g., a digital TV module) so as to improve the performance. Next, a digital TV will be taken as an example to further illustrate the implementation of the present invention.

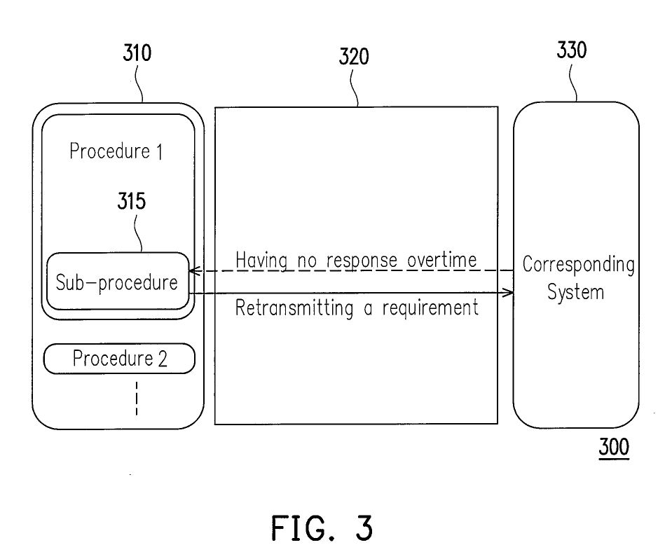

Referring to FIG. 3, a schematic view of a digital TV system according to another embodiment of the present invention is shown. A digital TV system 300 includes a host system 310, a communication interface 320 and a corresponding system 330. The host system 300 can be a simplex system in the digital TV, the corresponding system 330 represents a system that can communicate or transmit messages with the host system 310, for example, a digital TV module, and the communication interface 320 is, for example, RS232, Transmission Control Protocol and the Internet Protocol (TCP/IP), etc. The host system 310 has a major loop including multiple procedures (only Procedures 1 and 2 are shown in FIG. 3). Procedure 1 needs to conduct a transmission or a confirmation of a communication message with the corresponding system 330, and thus a sub-procedure 315 is included in Procedure 1, which serves to transmit a communication message or a command requiring a response, and to process the response of the corresponding system 330 for the communication message.

Likewise, Sub-procedure 315 has a transmitting sub-procedure and a processing sub-procedure, which serves respectively to transmit a communication message and process a response of a corresponding system. After Sub-procedure 315 transmits a communication message of Procedure 1 to the corresponding system 330, the major loop in the host system 310 continues to execute the next procedure (Procedure 2). When the major loop goes back to Procedure 1, the response of the corresponding system 330 is processed in Sub-procedure 315. If the corresponding system 330 has no response overtime, a command requiring a response is retransmitted to the corresponding system (as shown in FIG. 3), and if the corresponding system 330 has responded, a response message from the corresponding system 330 is read through a buffer area. Since a data can be registered in the buffer area in a general duplex transmission system, even if the simplex system 310 is executing other procedures, the response message from the corresponding system 330 can be first stored directly in the buffer area.

After Sub-procedure 315 conducts a corresponding processing according to different conditions, the major loop continues to execute the next procedure and does not wait for the response of the corresponding system 330. The next action (for example, transmitting a requirement again or cancelling a requirement) will not be conducted via Sub-procedure 315 until Procedure 1 is re-executed in the major loop. Accordingly, no matter whether the corresponding system 330 immediately responds to a requirement of the simplex system 300, the major loop in the simplex system 310 cannot be affected, thereby improving the operating performance of the digital TV. The other details relevant to the embodiment of FIG. 3 can make reference to FIG. 2, and will not be further described.

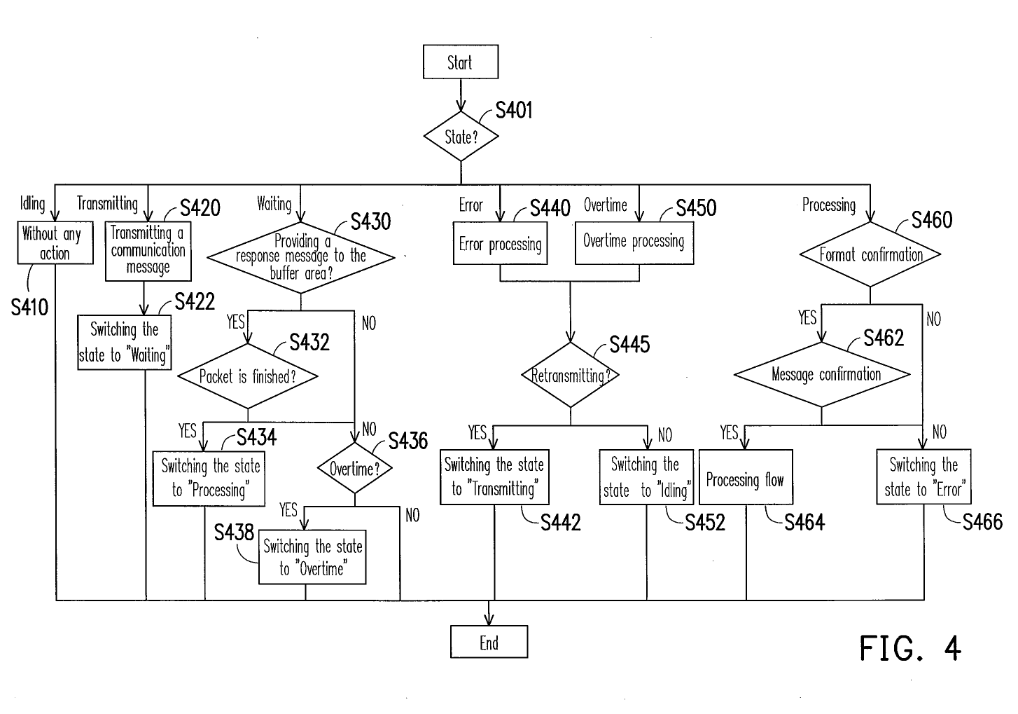

Next, a flowchart of a sub-procedure is further described. Referring to both FIGS. 3 and 4, and FIG. 4 is a flowchart of a sub-procedure according to another embodiment of the present invention. Step S401 is determination of a state. In this embodiment, states can include 6 types of executing states which are respectively “Idling”, “Transmitting”, “Waiting”, “Error”, “Overtime” and “Processing”. A sub-procedure can select a corresponding executing procedure according to a state content of Step S401. In this embodiment, a procedure of “Transmitting” can be shortly referred to as a transmitting sub-procedure, and procedures of “Waiting”, “Error”, “Overtime” and “Processing” can be shortly referred to as processing sub-procedures. Accordingly, the sub-procedures can be substantially classified into a transmitting sub-procedure and a processing sub-procedure which serves respectively to transmit and process a communication message.

First, a sub-procedure can be at an “Idling” state. Thus, if the simplex system 310 has not had a transmitting requirement for a communication message, the sub-procedure goes directly into Step S410, and ends without executing any action, so that the major loop continues to execute the next procedure.

When the simplex system 310 needs to transmit a communication message, the state of Step S401 is switched to “Transmitting”. Next, in Step S420, the communication message is transmitted to the corresponding system 330. Then, in Step S422, the state is switched to “Waiting”, and then the major loop continues to execute the next procedure. That is, when the major loop going into the sub-procedure next time, the state in Step S401 is “Waiting”.

When the major loop goes again into the sub-procedure, if the state in Step S401 is “Waiting”, then Step S430 is conducted to determine whether a response message from the corresponding system 330 is stored in the buffer area. If the answer is “YES (Y)”, then the Step 432 is conducted to confirm whether a packet transmission is finished. If the answer is “Y”, then Step S434 is conducted and the state is switched to “Processing”. If the corresponding system 330 does not provide a response message to the buffer area, then it is determined whether it is overtime in Step S436, and the state is switched to “Overtime” in Step S438. Then, the major loop is made to execute the next procedure.

When the major loop goes again into the sub-procedure, if the state in Step S401 is “Overtime”, Step S450 is conducted to execute an overtime processing, and it is determined whether to retransmit (Step S445) so as to switch the state to “Transmitting” (Step S442) or “Idling” (Step S452).

When the major loop goes again into the sub-procedure, if the state in Step S401 is “Processing”, Step S460 is conducted to make a format confirmation of a received data or confirmation message. If the format is wrong, the state is switched to “Error”, and if the format is correct, then a confirmation of the message content is made (Step S462) and a corresponding processing flow is conducted (Step S464).

When the major loop goes again into the sub-procedure, if the state in Step S401 is “Error”, the error processing is executed (Step S440), and it is determined whether to retransmit (Step S445) and the state is switched to “Transmitting” or “Idling” according to the result of the determination.

To sum up, when a state of a sub-procedure is changed, a procedure executing action thereof at present is finished, and a major loop in a simplex system continues to execute the next procedure. Only when the major loop goes again into the corresponding sub-procedure, the sub-procedure executes a procedure at the next state. Accordingly, even if a delayed response for a communication message of the simplex system occurs due to the corresponding system being busy, the major loop in the simplex system can be in a normal operation and is affected.

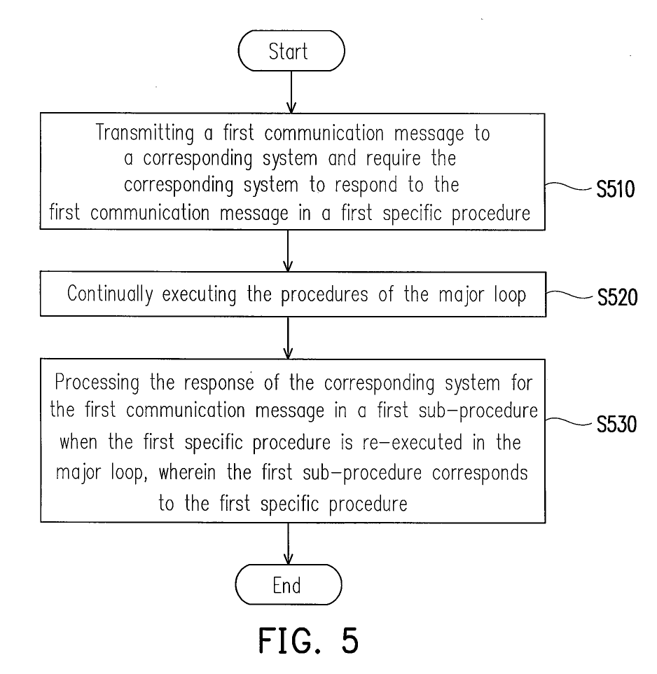

FIG. 5 is a flowchart of a procedure control method according to another embodiment of the present invention. The following description will make reference to both FIGS. 2 and 5. The above procedure control method is suitable for a simplex system in a digital TV. The simplex system has a major loop with multiple procedures. The procedure control method includes the following steps. First, in Step S510, transmit a first communication message to a corresponding system and require the corresponding system to respond to the first communication message (for example, requiring it to respond a confirmation message or a digital data) in a first specific procedure (e.g., Procedure 1).

Next, in Step S520, it is continually executing procedures of the major loop. Then, in Step S530, when the first specific procedure is re-executed in the major loop, the response of the corresponding system for the first communication message is processed in a first sub-procedure (e.g., Sub-procedure 210), wherein the first sub-procedure corresponds to the first specific procedure.

In Step S520, if a second communication message is output to the corresponding system and the corresponding system is required to respond to the second communication message in a second specific procedure (e.g., Procedure 2) of the major loop, when the second specific procedure is re-executed in the major loop, the response of the corresponding system for the second communication message is processed in a second sub-procedure (e.g., Sub-procedure 220), wherein the second sub-procedure corresponds to the second specific procedure. In this embodiment, the first specific procedure and the second specific procedure are used to distinguish different procedures, and meanwhile the first sub-procedure and the second sub-procedure are used to represent sub-procedures corresponding to different procedures. However, the technical manner of the present invention is not limited to the above terms, and meanwhile a procedure order suitable for the present invention is also not limited to the relative order of the above procedures (e.g., Procedures 1 and 2). The present invention can be applied to a simplex system with a different procedure relationship, and the details of implementation can be readily deduced by those of ordinary skill in the art through the disclosure of the present invention, and will not be further described.

The other technical details of the above embodiment of FIG. 5 have all been described in detail in the aforementioned embodiments of FIGS. 2-4, which can be readily deduced by those of ordinary skill in the art through the disclosure of the present invention, and will not be further described.

The idea of sub-procedures according to the present invention can be applied to make a major loop of a simplex system continue to execute other procedures when a corresponding system is too busy to respond immediately, and thus a reduced performance due to a response delay of the corresponding system can be avoided, thereby improving an overall performance of a digital TV.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A procedure control method for a simplex system in a digital TV, the simplex system having a major loop with multiple procedures, the procedure control method comprising:
transmitting a first communication message to a corresponding system and requiring the corresponding system to respond to the first communication message in a first specific procedure;
continually executing the procedures of the major loop; and
processing the response of the corresponding system for the first communication message in a first sub-procedure when the first specific procedure is re-executed in the major loop, wherein the first sub-procedure corresponds to the first specific procedure.

2. The procedure control method as claimed in claim 1, wherein the first sub-procedure of the first specific procedure comprises:
a first transmitting sub-procedure, for transmitting the first communication message to the corresponding system; and
a first processing sub-procedure, for processing the response of the corresponding system for the first communication message.

3. The procedure control method as claimed in claim 1, wherein the step of transmitting the first communication message to the corresponding system further comprises requiring the corresponding system to respond a confirmation message.

4. The procedure control method as claimed in claim 1, wherein the step of outputting the first communication message to the corresponding system further comprises requiring the corresponding system to respond a digital data.

5. The procedure control method as claimed in claim 1, wherein the step of processing the response of the corresponding system for the first communication message in the first sub-procedure further comprises re-requiring the corresponding system to respond to the first communication message and going into the step of continually executing the procedures of the major loop if the corresponding system has no respond to the first communication message overtime.

6. The procedure control method as claimed in claim 1, further comprising storing the message responded by the corresponding system in a buffer area if the corresponding system responds to the first communication message.

7. The procedure control method as claimed in claim 6, wherein in the step of processing the response of the corresponding system for the first communication message in the first sub-procedure, if the corresponding system responds to the first communication message, the message responded by the corresponding system is read through the buffer area.

8. The procedure control method as claimed in claim 1, wherein the step of continually executing the procedures of the major loop comprises outputting a second communication message to the corresponding system and requiring the corresponding system to respond to the second communication message in a second specific procedure.

9. The procedure control method as claimed in claim 8, further comprising:
processing the response of the corresponding system for the second communication message in a second sub-procedure when the second specific procedure is re-executed in the major loop, wherein the second sub-procedure corresponds to the second specific procedure.

10. The procedure control method as claimed in claim 9, wherein the second sub-procedure of the second specific procedure comprises:
a second transmitting sub-procedure, for transmitting the second communication message to the corresponding system; and
a second processing sub-procedure, for processing the response of the corresponding system for the second communication message.

11. The procedure control method as claimed in claim 9, wherein the step of processing the response of the corresponding system for the second communication message in the second sub-procedure comprises re-requiring the corresponding system to respond to the second communication message and going into the step of continually executing the procedures of the major loop if the corresponding system has no respond to the second communication message overtime.

12. The procedure control method as claimed in claim 9, further comprising storing the message responded by the corresponding system in a buffer area if the corresponding system responds to the second communication message.

13. The procedure control method as claimed in claim 1, wherein the corresponding system is a multiplex system.

14. The procedure control method as claimed in claim 1, wherein the corresponding system is a digital TV module.

15. The procedure control method as claimed in claim 1, wherein the simplex system is a host system of the digital TV.

16. The procedure control method as claimed in claim 1, wherein the simplex system is a scaler integrated circuit for operating the major loop.
